(19) United States
(12) Patent Application Publication
(10) Pub. No.: US 2022/0335286 A1
(43) Pub. Date: Oct. 20, 2022

(54) METHODS, SYSTEMS, ARTICLES OF MANUFACTURE, AND APPARATUS FOR DESIGNING HARDWARE

(71) Applicant: Intel Corporation, Santa Clara, CA (US)

(72) Inventors: Daniel Cummings, Austin, TX (US); Somdeb Majumdar, Mission Viejo, CA (US); Anthony Sarah, San Diego, CA (US)

(21) Appl. No.: 17/853,608

(22) Filed: Jun. 29, 2022

(51) Int. Cl. G06N 3/063; G06N 3/04; G06F 11/34

(52) U.S. Cl. CPC G06N 3/063; G06N 3/04; G06F 11/3457; G06F 11/3409

(57) ABSTRACT

Methods, apparatus, systems, and articles of manufacture are disclosed for designing hardware. An example apparatus includes processor circuitry to execute machine readable instructions to determine a first hardware architectural configuration of a hardware component based on a design constraint, simulate an execution of the first hardware architectural configuration for a plurality of workloads to generate a respective plurality of objective design spaces, the objective design spaces based on one or more objectives; generate an aggregate score by aggregating a plurality of design space performance indicators, ones of the plurality of design space performance indicators corresponding to respective ones of the plurality of objective design spaces; search a design database based on the aggregate score to identify a second hardware architectural configuration, and predict a performance of the second hardware architectural configuration to generate a performance metric by executing a proxy function corresponding to the second hardware architectural configuration.

### FIELD OF THE DISCLOSURE

This disclosure relates generally to hardware design and, more particularly, to methods, systems, articles of manufacture, and apparatus for designing hardware.

### BACKGROUND

Artificial intelligence (AI) algorithms can be computationally complex, requiring large amounts of time to train and execute. Accordingly, hardware acceleration has become popular in the field of AI and, more specifically, deep learning. A hardware accelerator is dedicated hardware used to speed up computational processes present in an AI workflow. Hardware accelerators can greatly decrease an amount of time it takes to train and execute an AI model, and can also be used to execute special AI-based tasks that cannot be conducted on a central processing unit (CPU). With traditional CPUs unable to keep up with the ever-increasing processing needs of demanding AI workloads, exponential data growth, and dense AI computations, the hardware acceleration market is growing rapidly.

### BRIEF DESCRIPTION OF THE DRAWINGS

FIG. 1 is a schematic illustration of an example hardware accelerator architecture for which examples disclosed herein can be applied.

FIG. 2 is a block diagram of an example design system structured in accordance with the teachings of this disclosure.

FIG. 3A is a graph depicting an example design space generated in accordance with the teachings of this disclosure.

FIG. 3B is a graph depicting another example design space generated in accordance with the teachings of this disclosure.

FIG. 4 is a schematic illustration of an example design space in accordance with the teachings of this disclosure.

FIG. 5 is a block diagram of an example implementation of the performance evaluator circuitry of FIG. 2.

FIGS. 6-8 are flowcharts representative of example machine readable instructions and/or example operations that may be executed by example processor circuitry to implement the design system of FIG. 2.

FIG. 9 is a block diagram of an example processing platform including processor circuitry structured to execute the example machine readable instructions and/or the example operations of FIGS. 6-8 to implement the design system of FIG. 2.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 6-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Current hardware accelerator design techniques are often performed manually, leveraging designer expertise to define and configure a hardware architecture. Such a manual design process can be quite time-consuming at least in part based on human limitations in view of an endless amount of possible hardware architectures and configurations for a given hardware architecture. For example, an application specific integrated circuit (ASIC) designer may need to define the hardware architecture by selecting hardware components (e.g., memory, processing element(s), etc.), determining placement of the hardware components (e.g., on a die), designing routing between the hardware components, etc. Further, the designer may need to configure the hardware accelerator architecture by selecting aspects (e.g., characteristics) of one or more of the hardware components, such as sizes of the hardware components, dataflow, order of operations, etc. to generate a hardware architectural configuration. As such, current techniques for hardware accelerators or other hardware components are limited to a constrained subset of hardware architectural configuration options.

Manual hardware design using a trial-and-error approach is a tedious task that necessitates architectural engineering skills and domain expertise. Thus, hardware accelerator design can be an expensive undertaking, costing tens to hundreds of millions of dollars. Current techniques for hardware accelerator design can include numerous iterations of hardware architectural configurations performed by team of skilled experts, including execution of time-consuming and computationally expensive simulations for each configuration. A hardware accelerator designer may start with a hardware architecture that seems promising and gradually modify a configuration of the architecture until settling on a design. For example, a hardware accelerator designer may focus on a Residual Network (ResNet) image classification architecture in a computer vision modality, iterating over and refining the accelerator design before settling on a configuration for the specific workload for the specific modality.

As disclosed herein, a workload refers to a program and/or algorithm that executes on a machine, including computational work (e.g., load) that the program imposes on underlying computing resources, such as a hardware accelerator. In other words, a workload corresponds to computations to be executed to perform a specific task (e.g., process data, analyze data, compute, etc.) on provided inputs (e.g., images, text, video, etc.) to produce an output (e.g., a prediction, an estimate, a classification, recognition, etc.). In some examples, a workload includes an AI model and corresponding data for processing. As disclosed herein, a modality refers to a way in which something happens, such as a way in which a machine can simulate human intelligence by analyzing a type of input data to produce a result. For example, modalities can include computer vision (e.g., extracting information from visual input), natural language processing (e.g., computational processing of human languages), etc. In the context of AI, input data may include images, text, audio, etc.

Based on the foregoing, manual hardware accelerator design techniques often result in hardware accelerators that are devised for a single performance objective (e.g., lowest latency for a given accuracy, highest accuracy for a given power level, etc.) for a single modality (e.g., NLP, etc.) and a single workload (e.g., Bidirectional Encoder Representations from Transformers (BERT), etc.). In some examples, a hardware accelerator designer can search over a subset of architecture design parameters for a single objective or workload at a time during a design process. However, a large gap exists hardware accelerator design that considers hardware accelerator performance in a multi-modal, multi-workload, and multi-objective setting.

While expert-driven design can yield good results for a specific objective, workload, and domain, a manual approach to hardware accelerator design has several limitations. For example, a manual design process can be an error-prone and time-consuming task, leading designers to settle on an architecture that is sufficient, rather than optimized or otherwise high-performing. Further, a specific hardware accelerator architecture may work well for a first workload (e.g., ResNet) within a single modality (e.g., image classification), but may not be as performant on a different workload (e.g., AlexNet) within the modality. Moreover, such a technique does not comprehend accelerator performance across different modalities and/or workloads, nor does such a technique consider accelerator performance for a large range of performance objectives (e.g., a multi-objective setting, many-objective setting, etc.). Considering the high cost of designing the hardware accelerator and the limited uses for which the hardware accelerator can be used based on current design techniques, a new technique is needed that can considers hardware accelerator performance in the multi-modal, multi-workload, and many-objective setting.

Methods, systems, articles of manufacture, and apparatus disclosed herein determine a high-performant hardware component (e.g., accelerator, chip, integrated circuit, etc.) design based on a set of constraints. Examples disclosed herein determine (e.g., automatically) a hardware architecture (e.g., a representation of a hardware system) for the component and a well-performing configuration of the hardware architecture (e.g., concurrently) to generate a hardware architectural configuration. As disclosed herein, a hardware architectural configuration refers to a representation of the hardware system including configurations. In some examples, automating hardware accelerator design and configuration can yield novel and/or better performing hardware architectural configurations for accelerators or other hardware components.

Example methods, systems, articles of manufacture, and apparatus disclosed herein determine the hardware architectural configuration based on input design constraints that define an architectural parameter(s) that can be adjusted during the configuration process, such a processing element(s) configuration, data tile sizing, dataflow configuration, order of operation during execution, etc. Based on the design constraint(s), certain examples select an initial (e.g., baseline, underlying, etc.) hardware architectural configuration. In some such examples, the initial hardware architectural configuration is determined from a search of a design space based on the input design constraints. In some examples, an underlying hardware architecture is input with the design constraint(s).

Examples disclosed herein apply performance modeling techniques to simulate an execution of a hardware architectural configuration for a different workloads across different modalities. Based on user- and/or system-defined workloads, disclosed examples monitor an execution of each workload as simulated on a hardware architectural configuration. Disclosed examples also utilize neural architecture search (NAS) techniques such as, but not limited to, evolutionary search, Bayesian optimization, and/or reinforcement learning to explore a search space of neural network architectures based on a workload to identify variations of the workload (e.g., sub-models, etc.). The search space can include a plurality of different neural networks, such as convolutional neural networks (CNNs) (e.g., for computer vision tasks), recurrent neural networks (RNN) (e.g., for language modeling tasks), etc.

Certain examples simulate execution of each workload and/or corresponding variations thereof to monitor performance of the hardware architectural configuration in view of one or more defined performance objectives. For example, methods, systems, articles of manufacture, and apparatus disclosed herein facilitate simulation a first workload (e.g., AI model) for a first modality on a current hardware architectural configuration to generate performance data. Certain examples additionally or alternatively simulate one or more variations of the first workload to generate additional or alternative performance data. Certain examples simulate a second workload and/or variations thereof for an additional or alterative modality to generate corresponding performance data. It is understood that examples disclosed herein can be used to simulate any number and/or type of workloads and/or variations thereof for any number of modalities on a current hardware architectural configuration.

Disclosed examples measure a performance of each workload and/or modality that is simulated on the hardware architectural configuration based on one or more performance objectives. For a given architecture and/or variations thereof, certain examples plot or otherwise structure performance data for a given workload and variations therefor to generate a design space for the workload based on a respective set of performance objectives. Based on a Pareto front of the design space(s) and one or more reference points, certain examples generate a performance indicator (e.g., metric) representing a multidimensional objective space that includes a set of solutions representing a tradeoff among the different objectives. The performance indicator can be, for example, a hypervolume indicator, an R2 indicator, etc. In examples in which two objectives are measured for each workload and/or modality of interest, the performance indicator may represent an area of an Pareto front. In some examples, a size of an objective design space indicates a fitness of a particular hardware architectural configuration for a corresponding workload.

Example methods, systems, articles of manufacture, and apparatus disclosed herein aggregate a set of design space performance indicators across the workloads and/or modalities of interest to generate an aggregate (e.g., holistic) score. In some examples, certain workloads can be given a stronger weight when generating the aggregate score to generate a weighted aggregate score. For example, if performance of a transformer attention-based workload is more important for an accelerator than performance of a MobileNetV3 convolutional-based workload, the transformer attention-based workload can be given a larger weight in a weighted aggregate score. In some examples, a weighted aggregate score can account for a number of workloads across modalities (e.g., computer vision, NLP, graph learning, etc.).

Example methods, systems, articles of manufacture, and apparatus disclosed herein leverage the aggregate score (or weighted aggregate score) to execute a search over a hardware architectural configuration design space from a multi-modal and many-objective aware perspective. Disclosed examples can apply a search algorithm (e.g., evolutionary search, Bayesian optimization, reinforcement learning, etc.) to search the hardware architectural configuration design space to identify hardware architectural configurations that perform well in relation to the aggregate score. Based on results of the search, disclosed examples may adjust the hardware architectural configuration.

In some examples, another round of simulations can be executed based on the adjusted hardware architectural configuration to generate another aggregate score based on a plurality of design space performance indicators. In some examples, such a process is considered a high-fidelity loop that produces a high-fidelity score. However, such simulations are time-consuming (e.g., high latency), computationally expensive (e.g., high compute cost), and typically need to be re-run from scratch each time the hardware architectural configuration is adjusted.

Certain examples mitigate the high costs associated with measuring (e.g., evaluating) performance of a hardware architectural configuration by generating (e.g., building) an example low-fidelity performance estimator that leverages structural information (e.g., graph) about the hardware architectural configurations to build a machine learning (ML) based proxy function. For example, the low-fidelity performance estimator can be computationally cheap version of the high-fidelity simulation, with high correlation to the high-fidelity simulation in terms of key performance indicators (KPIs). Thus, certain examples reduce design overhead associated with hardware accelerator design by utilizing a computationally cheaper (e.g., compared to a simulation) proxy function (e.g., using reinforcement learning, Bayesian optimization, etc.) to estimate a performance of the hardware architectural configuration typically determined during a simulation. During a design process for a hardware accelerator, example methods, systems, articles of manufacture, and apparatus disclosed herein determine high fidelity type measurements interspersed with low fidelity.

Certain example methods, systems, articles of manufacture, and apparatus continue to learn, process, and store information from past proposed architectures for a variety of workloads. Certain examples enable more targeted search suggestions and offer users more power, performance, and area (PPA) statistics for a final plan-of-record design. In some examples, the aggregate scoring metric can be used to tailor a design architecture to a specific use-case.

While examples disclosed below are discussed in terms of design of an ASIC, examples disclosed herein can be applied to the design of other hardware components in additional or alternative examples, such as other hardware accelerators, system on a chip (SOC) designs, and/or other chip designs. Further examples disclosed herein can be applied to design of software and/or firmware components in additional or alternative examples, such as AI architectures, etc. Examples disclosed herein can have a high impact across a design space in reducing design and/or configuration overhead associated with a hardware accelerator and/or another chip design. Certain examples can be applied to chip design techniques, neural architecture search techniques, molecular search, etc.

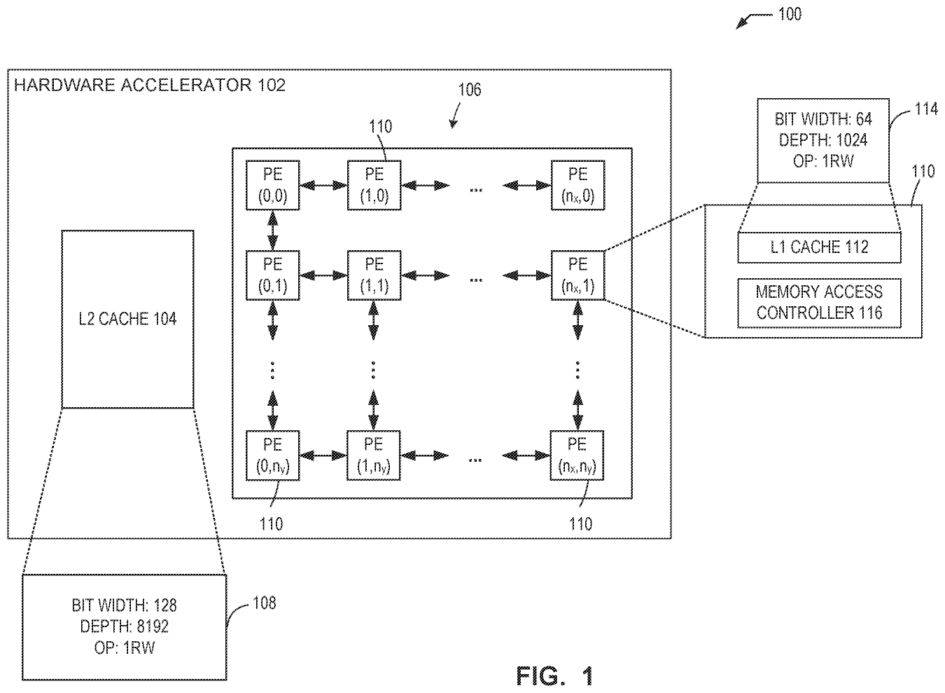

FIG. 1 is a schematic illustration of an example hardware accelerator architecture 100 for an example hardware accelerator (e.g., ASIC) 102. The hardware accelerator architecture 100 can be used for an acceleration task, such as a deep learning multiplying accumulator, tensor multiplication during forward pass or backward pass, etc. The example hardware accelerator 102 may obtain data, instructions, and/or signals from one or more external devices (not shown) via an interface (now shown) and output data, instructions, and/or signals to the one or more external devices via the interface.

The hardware accelerator 102 includes an example shared memory (e.g., Level 2 (L2) cache) 104 that is communicatively coupled to an example processing element (PE) array 106. The L2 cache 104 includes an example configuration 108 associated with different design variables. During a design process for the hardware accelerator 102, the different design variables for the L2 cache 104 need to be determined before manufacture. For example, the L2 cache 104 can support different bit widths (e.g., 8-bit, 16-bit, 32-bit, 64-bit, 128-bit, etc.) and different depths. Further, the L2 cache 104 can support different operation types, such as, but not limited to read only, one-read-write, etc.

The L2 cache 104 transmits data to the PE array 106, which includes a plurality of processing elements (e.g., processor(s), processing circuitry, etc.) 108 that apply an operation(s) on the data. The PE array 106 can correspond to a number of example configurations. For example, the PE array 106 can be pipelined (e.g., wherein each PE is designed for a particular processing task) and/or symmetric (e.g., wherein the PEs perform similar functionality). In a pipelined PE array 106, a PE 110 applies an operation on the data from the L2 cache 104 and transmits the processed data to a downstream PE 110.

Each PE 110 of FIG. 1 includes an example local memory (e.g., Level 1 (L1) cache, near memory cache, etc.) 112. In operation, the L1 cache(s) 112 does a large amount of leg work in terms of an operation itself of the PE 110 itself (e.g., moving data, executing an operation, etc.). Similar to the L2 cache 104, the L1 cache(s) 112 is associated with an example configuration 114 that includes different design variables that need to be determined before manufacture (e.g., different bit lengths, widths, operation types, etc.). In some examples, the PE(s) 110 can include a memory access control 116 that may be configured based on a configuration of the PE 110 and/or the PE array 106. In some examples, each PE 110 in a PE array 106 is substantially the same. In additional or alternative examples, one or more PEs in the PE array 106 can be different from one or more other PEs in the PE array 106.

Based on at least the foregoing, hardware accelerator design and configuration can be complex from a configuration perspective. The L2 cache 104 alone can correspond to any number of configurations. Moving up a level in a hierarchy of storages devices, each L1 cache 112 can correspond to a different width, depth, operation type, etc. The PE array 106 itself can include countless configurations. Further, the hardware accelerator 102 can include additional or alternative components, each of which may necessitate selection between a plurality of configurations. Moreover, other types of hardware are associated with similar issues of combinatorics, having an endless amount of possible hardware designs and configurations. Consequently, the combinatorics of hardware design leads to a complex and time-consuming design process that can be error-prone when done manually. Examples disclosed herein simplify the design process by automating the hardware architecture design process while simultaneously considering a large and diverse set of workloads that inform the hardware architectural configuration process.

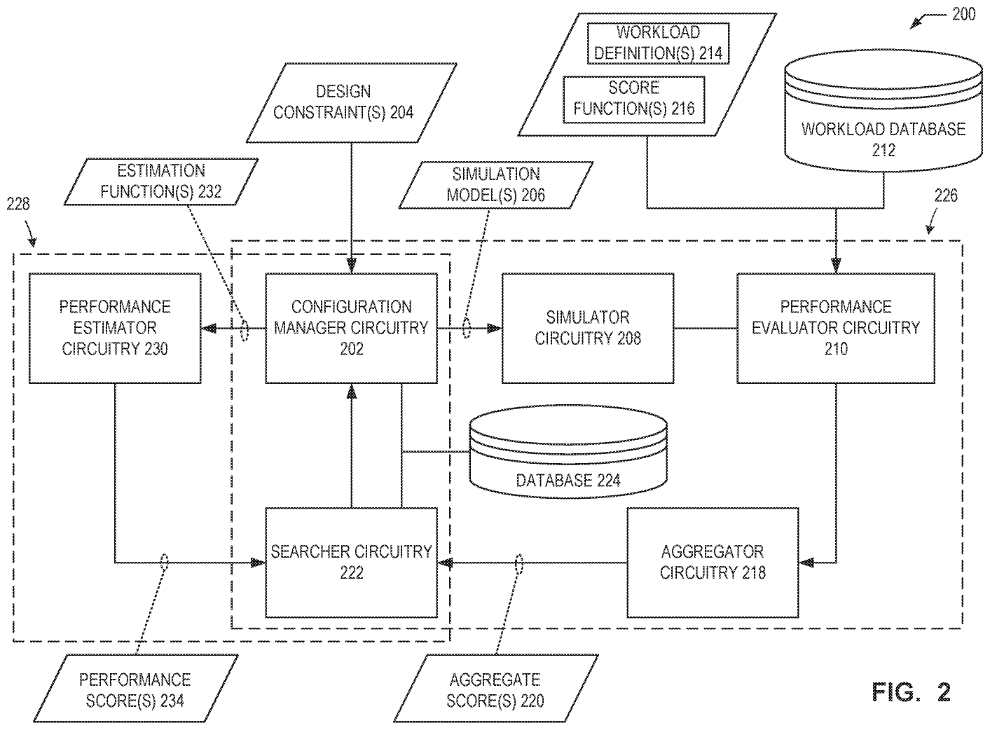

FIG. 2 is a block diagram of an example design system 200 structured in accordance with the teachings of this disclosure for determining a hardware architectural configuration. The design system 200 of FIG. 2 may be instantiated (e.g., creating an instance of, bring into being for any length of time, materialize, implement, etc.) by processor circuitry such as a central processing unit executing instructions. Additionally or alternatively, the design system 200 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

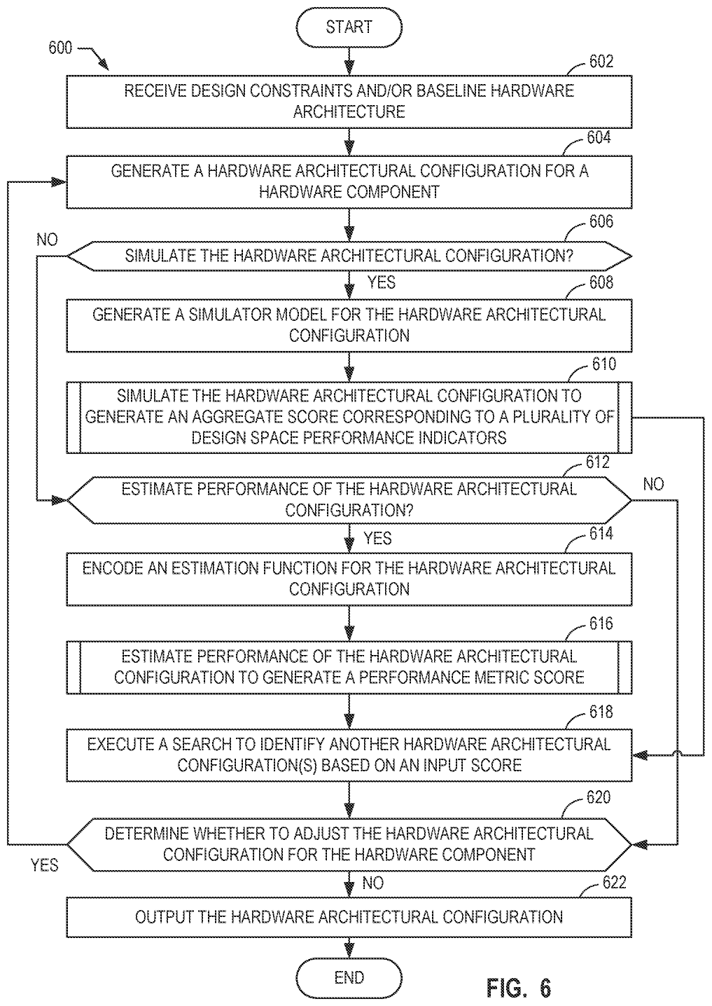

The design system 200 includes example configuration manager circuitry 202, which is structured to manage an architectural design representation for a hardware accelerator that can be used for hardware accelerator development. In some examples, the configuration manager circuitry 202 is instantiated by processor circuitry executing configuration manager instructions and/or configured to perform operations such as those represented by the flowchart of FIG. 6. In some examples, the configuration manager circuitry 202 is used during development of an application specific integrated circuit (ASIC). However, the configuration manager circuitry 202 can be used during development of other hardware components in additional or alternative examples, such as a field-programmable graph array (FPGA), an infrastructure processing unit (IPU), etc.

The configuration manager circuitry 202 of FIG. 2 receives example design constraints 204 (e.g., from a machine, a person, etc.) via an interface (not illustrated). The design constraints 204 can be architectural design constraints defining architectural parameters that can be adjusted during a configuration process. The design constraints 204 can include any number of configurable parameters based on any aspect of a hardware architectural configuration. In some examples, the design constraints 204 include processing element configuration(s) parameters. In some examples, the design constraints 204 include data tile sizing, dataflow configuration (e.g., pipelined versus symmetric, etc.), and/or order of operation during processing.

Based on the design constraints 204, the configuration manager circuitry 202 of FIG. 2 is structured to generate a hardware architectural configuration that represents a hardware accelerator. In some examples, the configuration manager circuitry 202 generates a first (e.g., baseline, underlying, etc.) hardware architectural configuration that can be adjusted (e.g., changed, modified) in accordance with the design constraints 204 based on performance data generated during the configuration process. In some examples, a first hardware architectural configuration is provided to the configuration manager circuitry 202 with the design constraints 204. In some examples, a first user-and/or system-defined hardware architecture is provided to the configuration manager circuitry 202 and the configuration manager circuitry 202 generates the baseline hardware architectural configuration based on the design constraints 204.

The hardware architectural configuration can be described in a hardware definition language (HDL), such as Verilog, VHDL, etc. A HDL is a computer language used to described structure and behavior of an electronic circuit. An HDL is a text description of structure(s) and behavior(s) of a circuit system. Utilizing an HDL enables a formal description of the hardware architectural configuration for use in automated analysis and simulation of the hardware architectural configuration. Further, the hardware architectural configuration can be defined using different levels of abstraction. For example, the hardware architectural configuration can be defined using a JavaScript Object Notation (JSON) file, a dictionary of design parameters, etc.

In some examples, the configuration manager circuitry generates an example simulation model(s) 206 based on the hardware architectural configuration for the hardware accelerator design. Rather than manufacturing a hardware accelerator based on the hardware architectural configuration for performance testing, execution of the simulation model 206 can facilitate an approximation of performance of the hardware architectural configuration. In some examples, the configuration manager circuitry 202 transmits the simulation model 206 to example simulator circuitry 208.

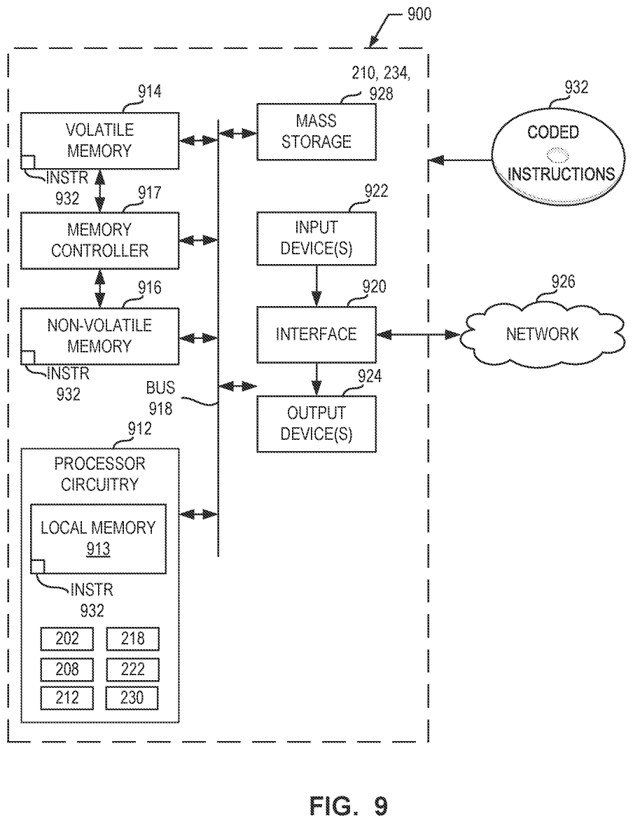

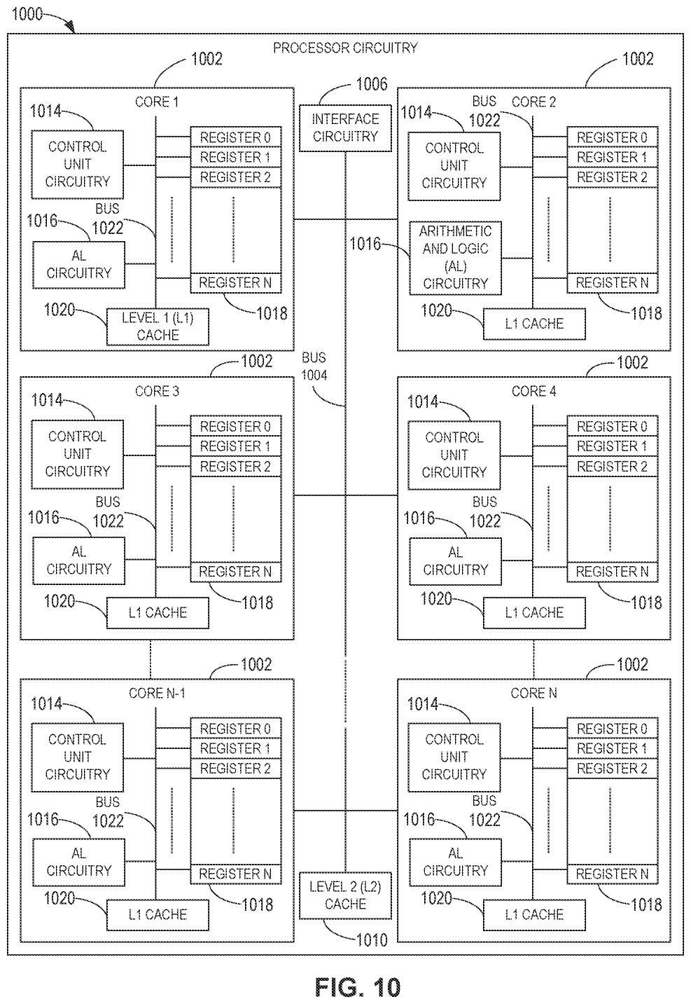

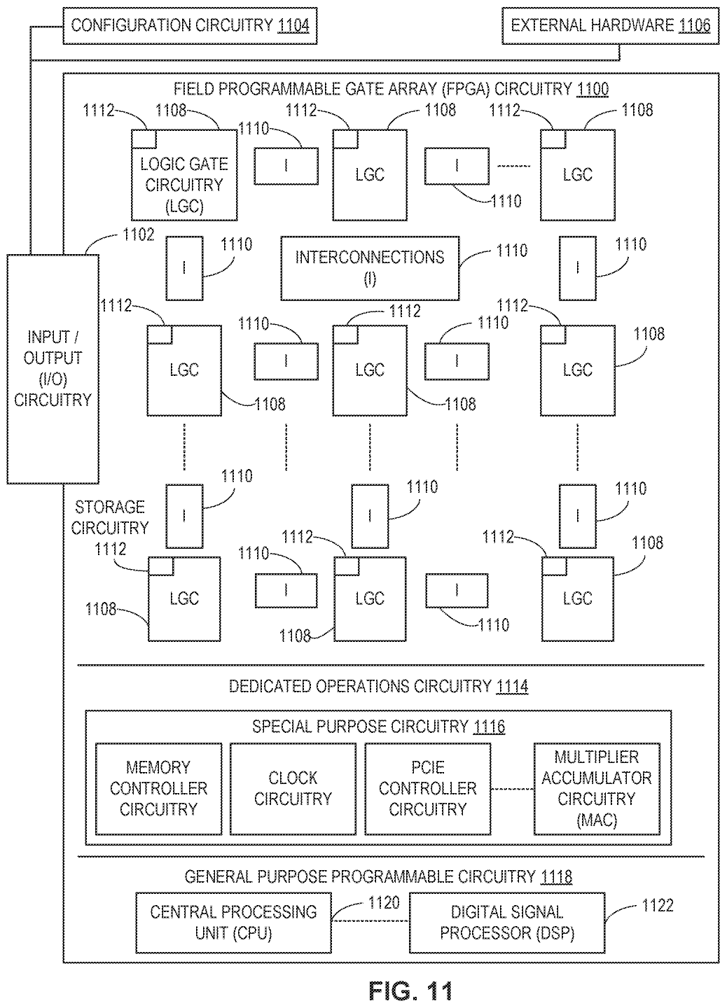

In some examples, the design system 200 includes means for configuring a hardware architecture for a hardware component. For example, the means for configuring may be implemented by configuration manager circuitry 202. In some examples, the configuration manager circuitry 202 may be instantiated by processor circuitry such as the example processor circuitry 912 of FIG. 9. For instance, the configuration manager circuitry 202 may be instantiated by the example microprocessor 1000 of FIG. 10 executing machine executable instructions such as those implemented by at least blocks 602, 604 of FIG. 6. In some examples, the configuration manager circuitry 202 may be instantiated by hardware logic circuitry, which may be implemented by an ASIC, XPU, or the FPGA circuitry 1100 of FIG. 11 structured to perform operations corresponding to the machine readable instructions. Additionally or alternatively, the configuration manager circuitry 202 may be instantiated by any other combination of hardware, software, and/or firmware. For example, the configuration manager circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

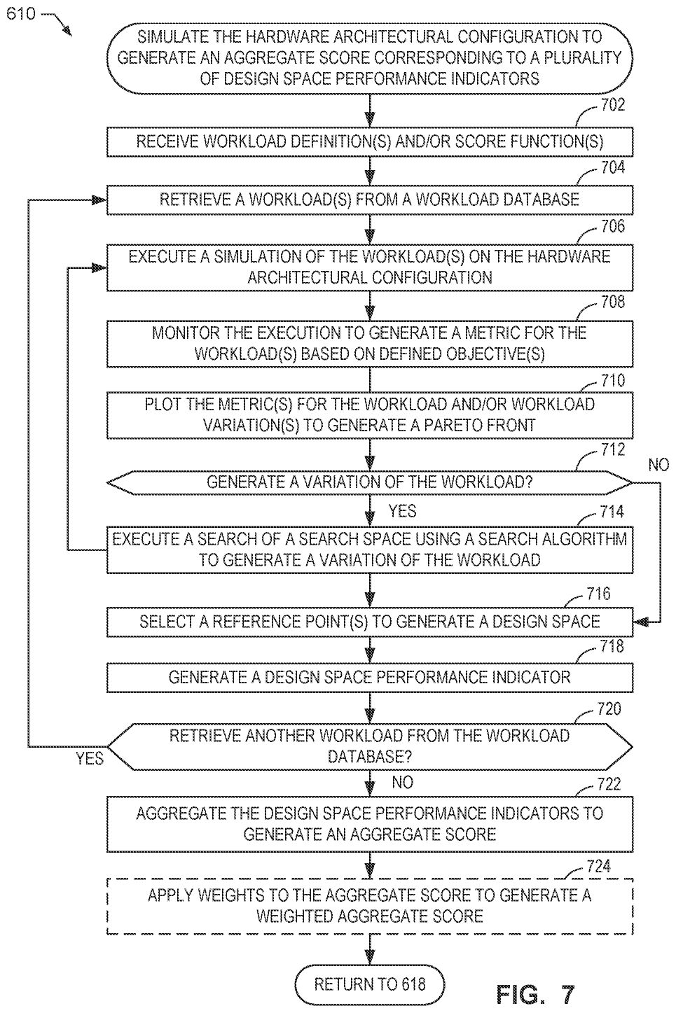

The design system 200 includes the simulator circuitry 208, which is structured to execute the simulation model 206 to simulate the hardware architectural configuration in operation. In some examples, the simulator circuitry 208 is instantiated by processor circuitry executing simulator instructions and/or configured to perform operations such as those represented by the flowchart of FIG. 7. The simulator circuitry 208 executes the simulation model 206 based on one or more workloads to determine performance of the hardware architectural configuration in view of the workload(s). In some examples, execution of the simulation model 206 by the simulator circuitry 208 is considered a high fidelity measurement (e.g., high accuracy estimation of a hardware component).

In some examples, the design system 200 includes means for simulating an execution of a hardware architectural configuration. For example, the means simulating may be implemented by simulator circuitry 208. In some examples, the simulator circuitry 208 may be instantiated by processor circuitry such as the example processor circuitry 912 of FIG. 9. For instance, the simulator circuitry 208 may be instantiated by the example microprocessor 1000 of FIG. 10 executing machine executable instructions such as those implemented by at least blocks 610 of FIGS. 6-7. In some examples, the simulator circuitry 208 may be instantiated by hardware logic circuitry, which may be implemented by an ASIC, XPU, or the FPGA circuitry 1100 of FIG. 11 structured to perform operations corresponding to the machine readable instructions. Additionally or alternatively, the simulator circuitry 208 may be instantiated by any other combination of hardware, software, and/or firmware. For example, the simulator circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The design system 200 includes example performance evaluator circuitry 210, which is communicatively coupled to the simulator circuitry 208. The performance evaluator circuitry 210 is structured to manage an evaluation(s) of a workload(s) (e.g., as defined in an example workload database 212) as executed on a hardware architectural configuration during execution of the simulation model 206 to generate performance data based on one or more performance objectives (e.g., functions, trade-offs, etc.). In some examples, the performance evaluator circuitry 210 is instantiated by processor circuitry executing performance evaluator instructions and/or configured to perform operations such as those represented by the flowchart of FIG. 7.

The example workload database 212 is structured to store workload(s) that can be used during simulation of a hardware architectural configuration. In some examples, the workload database 212 can store example AI model(s) (e.g., trained and/or pre-trained), DNN workload(s), other workload types, datasets, etc. across different modalities and/or domains. Domains can include text problem domains (e.g., embedding, language model, classification, retrieval question answering, etc.), image problem domains (e.g., classification, detection, etc.), video problem domains (e.g., detection, recognition, etc.), and/or audio problem domains (e.g., embeddings, etc.). For example, the workload database 212 can include workloads such as, but not limited to ResNet models, AlexNet models, transformers, and/or any other workload that can execute on a given hardware architectural component. In some examples, the workload database 212 stores workloads that are compatible with the performance evaluator circuitry 210. However, the workload database 212 stores other workloads in additional or alternative examples. In some examples, the workload database 212 includes an interface that enables new workloads (e.g., workloads not already in the workload database 212) to be added to the workload database 212. For example, the interface can allow the new workloads to be added automatically during a design process (e.g., from the performance evaluator circuitry 210), manually by a user, etc.

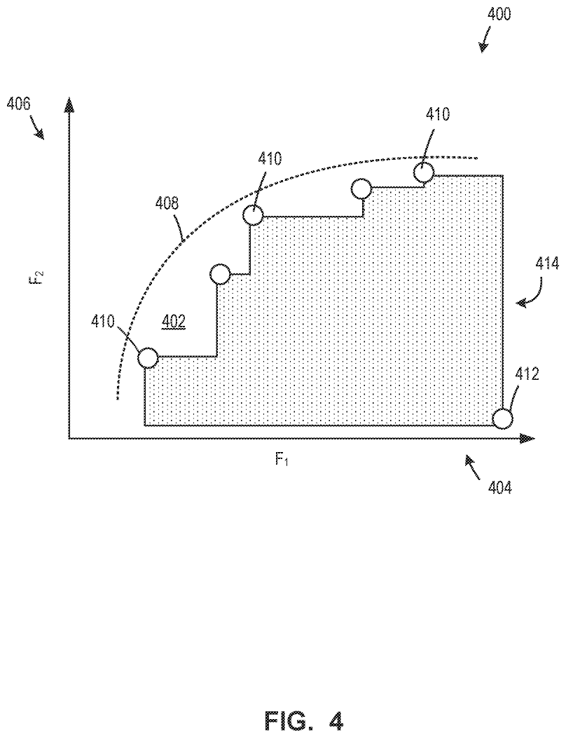

The performance evaluator circuitry 210 of FIG. 2 (discussed in detail below in relation to FIG. 4) receives an example workload definition(s) 214 and/or an example score function(s) 216 as an input (e.g., from a machine, a user, etc. via an interface(s)). The workload definition(s) 214 can define which workload(s) from the workload database 212 and/or from another source to simulate. For example, the workload definition(s) 214 can include different workloads across different modalities to simulate and inform the design process. The score function(s) 216 can define how the defined workload(s) should be used to inform the hardware accelerator architecture design process (e.g., by way of a performance indicator(s) and aggregate score). For example, the score function(s) 216 can include performance objectives of interest (e.g., maximize or otherwise increase accuracy, minimize or otherwise reduce latency, etc.), a weight(s) that indicates a greater importance of one or more workloads, etc. Consequently, the workload definition(s) 214 and/or the score function(s) 216 can influence final hardware accelerator design characteristics.

The performance evaluator circuitry 210 is structured to identify which workload(s) to simulate and/or determine how such workloads should inform the design process based on the workload definition(s) 214 and/or the score function(s) 216. The performance evaluator circuitry 210 can transmit a defined workload to the simulator circuitry 208 for execution. In response, the simulator circuitry 208 can execute the simulation model 206 of the hardware architectural configuration based on the workloads. Rather than focusing on one single workload (e.g., a ResNet type model, a MobileNetV3 type model, etc.), the performance evaluator circuitry 210 can apply NAS techniques (e.g., evolutionary search, Bayesian optimization, reinforcement learning, etc.) to explore a search space and identify a diverse set of sub-models of a particular workload, enabling the performance evaluator circuitry 210 to utilize a diverse set of workloads inform the configuration progress. For example, the performance evaluator circuitry 210 can identify different workloads across different modalities, and use NAS techniques to identify variations of those workloads. The performance evaluator circuitry 210 can input each workload and/or variations thereof into the simulator circuitry 208 (e.g., one at a time) to be executed with the simulation model 206.

The performance evaluator circuitry 210 measures one or more performance metric values based on defined performance objectives for each workload and variations thereof during execution. In some examples, the performance evaluator circuitry 210 plots the performance metric values for the workload and variations thereof in a graph or other structure to generate Pareto front for the given workload type.

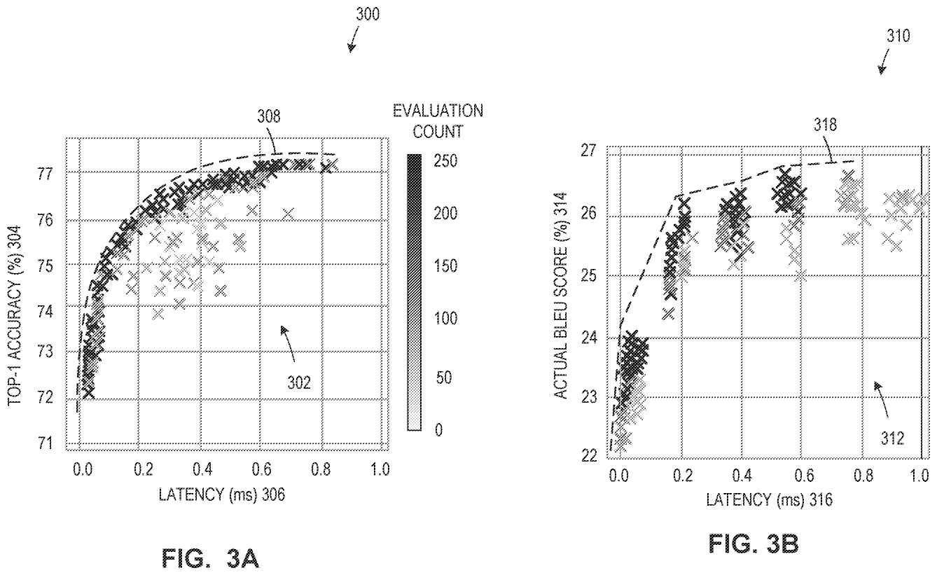

FIG. 3A is an illustration of an example NAS generated Pareto front for different workloads in accordance with the teachings of this disclosure. FIG. 3A includes a graph 300 that includes example data points 302 representing different workloads that are plotted based on measured performance metric values. For example, a first data point can represent a first MobileNetV3 model executed by a simulated hardware architectural configuration, while a second or other subsequent data point(s) can represent a variation of the first MobileNetV3 model. The graph 300 of FIG. 3A illustrates performance of the different workloads 302 based on a top-1 accuracy (e.g., Y-axis) 304 objective relative to latency (e.g., X-axis) 306 objective for the workloads. That is, the graph 300 illustrates how each MobileNetV3 model variation would look like in the top 1 accuracy 304 in view of latency 306.

The graph 300 includes an example pareto front 308. Generally, a pareto front includes a plurality of linked Pareto points, which correspond to multi-objective data points. In the example of FIG. 3, the Pareto points correspond to accuracy-latency data points. A given data point is determined to be a Pareto point if there no other point is both faster and more accurate than the given point.

FIG. 3B is an illustration of another example NAS generated Pareto front for different workloads in accordance with the teachings of this disclosure. FIG. 3B includes a graph 310 that includes data points 312 representing different workloads. In the example of the FIG. 3B, at least a portion of the data points can represent variations of a Transformer model (e.g., generated by the performance evaluator circuitry 210). For example, a first data point can represent a first Transformer model executed by a simulated hardware architectural configuration while other data points can represent a variation(s) of the first Transformer model.

The graph 310 illustrates performance of the workloads based on an actual Bilingual Evaluation Understudy (BLEU) score (e.g., Y-axis) 314 objective relative to a latency (ms) (e.g., X-axis) 316 objective for the different workloads. A BLEU score 314 is a performance metric used to evaluate an NLP model. The BLEU score 314 is based on the idea that a predicted sentence (e.g., by a machine) that is closer to a human-generated target sentence is better than a predicted sentence that is more dissimilar to the human-generated target sentence. The graph 310 includes an example pareto front 318, which includes a plurality of linked BLEU-latency Pareto points. That is, a given data point is determined to be a Pareto point if there is no other point which is both faster and more accurate than the given point.

Referring again to FIG. 2, the performance evaluator circuitry 210 utilizes NAS generated data structures, such as the graphs 300, 310 of FIGS. 3A and 3B to generate a performance indicator representing objective design space for a given workload (e.g., herein referred to as a design space performance indicator). In some examples, the performance evaluator circuitry 210 generates a design space performance indicator for each workload and/or modality of interest. Examples discussed below assume that the design space performance indicator is a hypervolume indicator. However, the design space performance indicator can be an R2 indicator, a variance metric, and/or another goodness metric that considers a distribution of vectors in additional or alternative examples. In some examples, the design space performance indicator is a fitness function. When measuring two objectives (e.g., latency versus accuracy, etc.), a hypervolume represents an area of a Pareto front. For example, in a case of measuring latency versus accuracy objectives, the larger the hypervolume indicator value, the better the performance of the hardware architectural configuration. However, it is understood that any number of objectives (e.g., latency, accuracy, FLOPS (Floating Point Operations per Second), power, etc.) can be used for generating the design space performance indicators.

FIG. 4 is a graph 400 for a multi-objective determination problem that can be output by the example performance evaluator circuitry 210 of FIG. 2. The graph 400 includes an example design space 402, which is a space of possible solutions that can be evaluated using objective functions. The example graph 400 compares an example first objective function (F1) (e.g., X-axis) 404 to an example second objective function (F2) (e.g., Y-axis) 406. In some examples, the first objective function 404 and/or the second objection 406 is maximization or increase of a characteristic (e.g., accuracy, etc.). In some examples, the first objective function 404 and/or the second objection 406 is minimization or reduction of a characteristic (e.g., latency, power, FLOPS, etc.).

The graph 400 includes an example Pareto front 408, which represents a high-performant set of AI architecture design configurations. Generally, a Pareto approach to optimal experimental design simultaneously considers multiple objectives (e.g., latency, accuracy, FLOPS, power, etc.) by constructing a set of Pareto designs while explicitly considering trade-offs between opposing criteria. Considering multiple objectives can be a challenge, especially considering that improving one objective often compromises another (e.g., increasing accuracy of a model likely increases latency of the model). As a result, a workload typically does not include a best architecture, but rather a set of architectures exhibiting trade-offs between objectives. The trade-offs are typically based on computable equations.

The graph 400 includes example Pareto points 410, each of which represent a workload execution simulated on a current hardware architectural configuration. The graph 400 also includes an example reference point(s) 412 and an example hypervolume 414. The hypervolume 414 is a unary performance indicator that provides a measure to quantify a quality of the Pareto front 408. The hypervolume 414 is a measure of a size of an objective design space (e.g., an area in a bi-objective setting, a volume in a many-objective setting, etc.) enclosed by solutions on the Pareto front 408 and the reference point 412. That is, the reference point 412 is needed to calculate and define the hypervolume 414. In some examples, the hypervolume 414 for the Pareto front 408 is determined as an objective space that is dominated by the Pareto front 408 relative to some reference point 412.

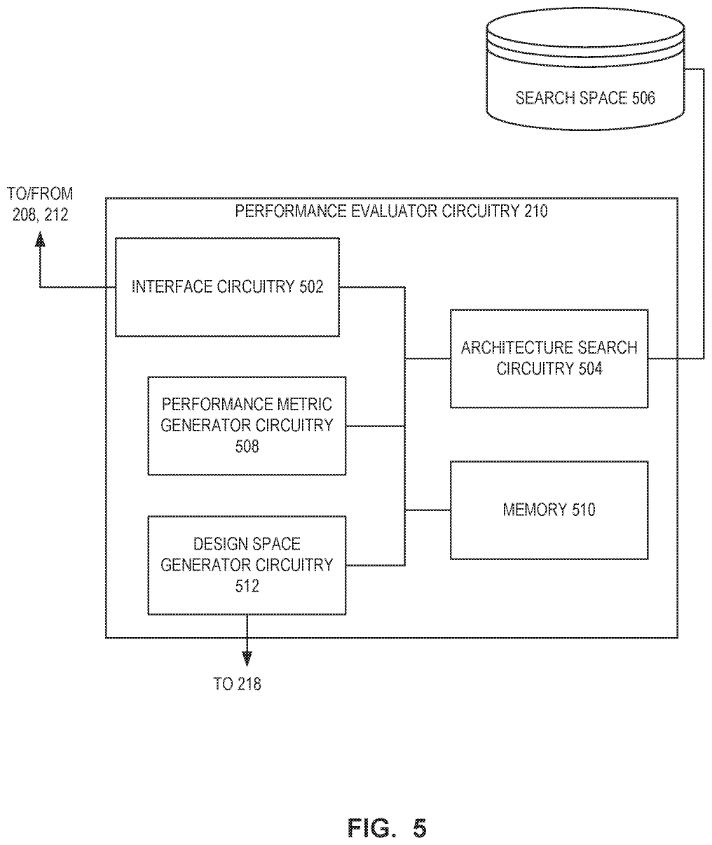

While only one reference point 412 is illustrated in the example of FIG. 5, more than one reference point 412 can be used in additional or alternative examples. The reference point(s) 412 can be selected (e.g., by user, machine, etc.) using different approaches. In some examples, the reference point(s) 412 can be selected using a rule of thumb, such as selecting a reference point(s) 412 at a corner of a design space that is larger (e.g., 1% larger, larger by an additive term of 1, etc.) than an actual objective space. In some examples, the reference point(s) 412 can be selected as a nadir point.

In some examples, the design system 200 includes means for generating a design space performance indicator. For example, the means for generating a design space performance indicator may be implemented by performance evaluator circuitry 210. In some examples, the performance evaluator circuitry 210 may be instantiated by processor circuitry such as the example processor circuitry 912 of FIG. 9. For instance, the performance evaluator circuitry 210 may be instantiated by the example microprocessor 1000 of FIG. 10 executing machine executable instructions such as those implemented by at least blocks 702-718 of FIG. 7. In some examples, the performance evaluator circuitry 210 may be instantiated by hardware logic circuitry, which may be implemented by an ASIC, XPU, or the FPGA circuitry 1100 of FIG. 11 structured to perform operations corresponding to the machine readable instructions. Additionally or alternatively, the performance evaluator circuitry 210 may be instantiated by any other combination of hardware, software, and/or firmware. For example, the performance evaluator circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

Referring again to FIG. 2, the design system 200 includes example aggregator circuitry 218, which is structured aggregate design space performance indicators generated by the performance evaluator circuitry 210 to generate an example aggregate score 220. In some examples, the aggregator circuitry 218 is instantiated by processor circuitry executing score aggregator instructions and/or configured to perform operations such as those represented by the flowchart of FIG. 6. The aggregate score 220 facilitates a way to efficiently and correctly aggregate large Pareto front spaces across different modalities.

The aggregator circuitry 218 receives or otherwise retrieves a plurality (e.g., set) of design space performance indicators corresponding to a hardware architectural configuration from the performance evaluator circuitry 210. Aggregate data is high-level data obtained by combining individual-level data. The aggregator circuitry 218 aggregates the set of design space performance indicators across simulated workloads to generate the aggregate score 220, which is fed example searcher circuitry 222 (discussed below). In some examples, the aggregator circuitry 218 can average the set of design space performance indicators to generate the aggregate score 220. However, the aggregator circuitry 218 can use other methods to aggregate the design space performance indicators in additional or alternative examples. In some examples, the aggregator circuitry 218 can generate the aggregate score 220 based on a format used by example searcher circuitry 222. For example, the searcher circuitry 222 (discuss in detail below) may apply a search algorithm that uses a relative ranking of different scores (e.g., 0-1000, 0-1, etc.). In some such examples, the aggregator circuitry 218 can generate the aggregate score 220 such that the aggregate score 220 is in accordance with the ranking scale.

In some examples, the design system 200 includes means for aggregating a plurality of design space performance indicators. For example, the means for aggregating may be implemented by aggregator circuitry 218. In some examples, the aggregator circuitry 218 may be instantiated by processor circuitry such as the example processor circuitry 912 of FIG. 9. For instance, the aggregator circuitry 218 may be instantiated by the example microprocessor 1000 of FIG. 10 executing machine executable instructions such as those implemented by at least blocks 722-724 of FIG. 7. In some examples, the aggregator circuitry 218 may be instantiated by hardware logic circuitry, which may be implemented by an ASIC, XPU, or the FPGA circuitry 1100 of FIG. 11 structured to perform operations corresponding to the machine readable instructions. Additionally or alternatively, the aggregator circuitry 218 may be instantiated by any other combination of hardware, software, and/or firmware. For example, the aggregator circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The design system 200 includes the searcher circuitry 222, which is structured to execute a search of a hardware design search space based on an input metric score (e.g., aggregate score(s) 220 and/or estimate score(s) 234, discussed below) to identify potential hardware architectural configuration designs. In some examples, the searcher circuitry 222 is instantiated by processor circuitry executing searcher instructions and/or configured to perform operations such as those represented by the flowchart of FIG. 6. The searcher circuitry 222 of FIG. 2 applies an AI algorithm, such as, but not limited to, Bayesian optimization, reinforcement learning, evolutionary, and/or gradient optimization to search (e.g., explore) various architectural configurations to find architectures that perform best with relation to the aggregate score 220. In the example of FIG. 2, the searcher circuitry 222 searches an example design database 224 of the design system 200. However, the searcher circuitry 222 can search other sources (e.g., database(s), datastore(s), library(ies), etc.) in additional or alternative examples.

The design database 224 of FIG. 2 is structured to store information, such as numerous different hardware architectural configurations, scores (e.g., aggregate score(s) 220, estimate score(s) 234, etc.), and/or other information corresponding to the hardware architectural configurations. The design database 224 stores hardware architectures from generated by the configuration manager circuitry 202 and/or from additional or alternative sources. For example, the design database 224 can store known hardware architectures, etc.

Based on the search, the searcher circuitry 222 identifies one or more hardware architectural configurations that are within the design constraints 204 and may be more performant than a current hardware architectural configuration based on a generated score. In response, the configuration manager circuitry 202 determines whether to adjust a current hardware architectural configuration and/or adjusts the current hardware architectural configuration.

In some examples, the design system 200 includes means for searching a design space. For example, the means for searching may be implemented by searcher circuitry 222. In some examples, the searcher circuitry 222 may be instantiated by processor circuitry such as the example processor circuitry 912 of FIG. 9. For instance, searcher circuitry 222 may be instantiated by the example microprocessor 1000 of FIG. 10 executing machine executable instructions such as those implemented by at least blocks 618 of FIG. 6 and/or 714 of FIG. 7. In some examples, the searcher circuitry 222 may be instantiated by hardware logic circuitry, which may be implemented by an ASIC, XPU, or the FPGA circuitry 1100 of FIG. 11 structured to perform operations corresponding to the machine readable instructions. Additionally or alternatively, the searcher circuitry 222 may be instantiated by any other combination of hardware, software, and/or firmware. For example, the searcher circuitry 222 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

An example high-fidelity loop 226 can be defined by the configuration manager circuitry 202, simulator circuitry 208, performance evaluator circuitry 210, aggregator circuitry 218, and the searcher circuitry 222. The high fidelity loop 226 is used to simulate an execution of the hardware architectural configuration across workloads and/or modalities of interest in a multiple-objective setting. The high fidelity loop 226 can provide substantially accurate results in terms of performance by simulating execution of the workloads on the hardware architectural configuration. As disclosed herein, a substantially accurate result corresponds to a simulated execution of a hardware component as compared to an execution of the hardware component as manufactured with a same workload. A substantially accurate result is dependent on a specific scenario. In some examples, a substantially accurate result may be a result of the simulated execution that is within 5% of a results as obtained by executing the same workloads on corresponding hardware. In some examples, a substantially accurate result can be a result of the simulated execution that more than 25% of a result as obtained by executing the same workloads on corresponding hardware (e.g., as can often be seen in relation to power estimates. However, the high fidelity loop 226 can be costly. For example, one iteration of the high fidelity loop 226 (e.g., for one configuration) includes generation and/or adjustment of a hardware architectural configuration, generation and/or adjustment of a simulation model for the hardware architectural configuration, execution of a set of neural architecture search processes to generate diverse sets of workloads, simulations of executions of those workloads to generate a plurality of design space performance indicators, aggregation of the design space performance indicators, and execution of a search based on the aggregation. Further, from a configuration (e.g., and/or optimization) perspective, the more iterations of a high fidelity loop 226 that are completed, the better the results (e.g., form an algorithmic perspective).

Thus, the design system 200 includes an example low-fidelity loop 228 to mitigate the high cost of evaluating hardware architectures by executing a low-fidelity performance estimator that leverages structural information about the accelerator configurations. For example, a hardware architectural configuration may be represented by a graph, hash table, dictionary of components, and/or another structural representation. In some examples, the low fidelity loop 228 includes the configuration manager circuitry 202, example performance estimator circuitry 230, and/or the searcher circuitry 222. Instead of running through a full high-fidelity loop 226 until a final hardware architectural configuration is determine, the configuration manager circuitry 202 can run through the low fidelity loop 228 one or more times before returning to the high fidelity loop 226. For example, the configuration manager circuitry 202 may utilize the low-fidelity loop 228 a defined number of iterations and/or until a performance score generated by the low-fidelity loop 228 reaches a defined (e.g., threshold) value before returning to the high-fidelity loop 226. That is, in some examples, the configuration manager circuitry 202 go back and forth between both loops 226, 228 (e.g., depending on compute requirements of each) to inform the design process.

The design system 200 includes the performance estimator circuitry 230, which is structured execute an example estimation (e.g., proxy) function(s) 232 that estimates performance of a hardware architectural configuration to generate a performance score (e.g., metric) 234. In some examples, the performance estimator circuitry 230 is instantiated by processor circuitry executing performance estimator instructions and/or configured to perform operations such as those represented by the flowchart of FIG. 6. In the example of FIG. 2, the configuration manager circuitry 202 encodes an estimation function (e.g., representation) 232 of the hardware architectural configuration for execution by the performance estimator circuitry 230. In additional or alternative examples, the performance estimator circuitry 230, another component, and/or a user encodes the estimation function 232 of the hardware architectural configuration. The performance estimator circuitry 230 can manage training and prediction of hardware architectural configuration performance based on the estimation function 232.

The estimation function(s) 232 as executed by the performance estimator circuitry 230 of FIG. 2 applies a graph-based prediction algorithm to generate an example score(s) 234. For example, the estimation function 232 can generate a graph representation of a PE array considering that most hardware architectures (e.g., from a circuit design perspective) can be represented as a graph. In some examples, another general regressor (e.g., linear ridge, graph neural network regressor, etc.) can be used additionally or alternatively. For example, a graph neural network regressor can comprehend the structural components of different accelerator configurations, enabling a more accurate performance metric. However, it is understood that the estimation function(s) 232 can encode a hardware architectural configuration in any number of manners and/or using any suitable method. In some examples, the estimation function 232 represents a hardware architectural configuration as a vector. For example, the estimation function 232 can include a hash table, a dictionary of each of processing element in a processing element array, and/or another structure, with different design variable options associated with each processing element. The estimation function 232 can estimate performance by treating the structure as a configuration space.

The performance estimator circuitry 230 generates a performance score(s) 234 of a hardware architectural configuration based on execution of the estimation function(s) 232. In some examples, the performance estimator circuitry 230 generates a performance guess without knowledge of the aggregate score(s) 220. In additional or alternative examples, the performance estimator circuitry 230 can treat generation of the performance guess as an ML prediction problem. In some such examples, the performance estimator circuitry 230 may train a predictor on known high-fidelity results (e.g., aggregate score(s) 220). The performance estimator circuitry 230 transmits the performance score(s) 234 to the searcher circuitry 222. In response, the searcher circuitry 222 executes a search of a hardware design search space based on the performance score(s) 234 to identify potential hardware architectural configuration designs. As noted above, the searcher circuitry 222 identifies one or more hardware architectural configurations that are within the design constraints 204 and may be more performant than a current hardware architectural configuration based on the performance score(s) 234. In response, the configuration manager circuitry 202 determines whether to adjust a current hardware architectural configuration and/or adjusts the current hardware architectural configuration.

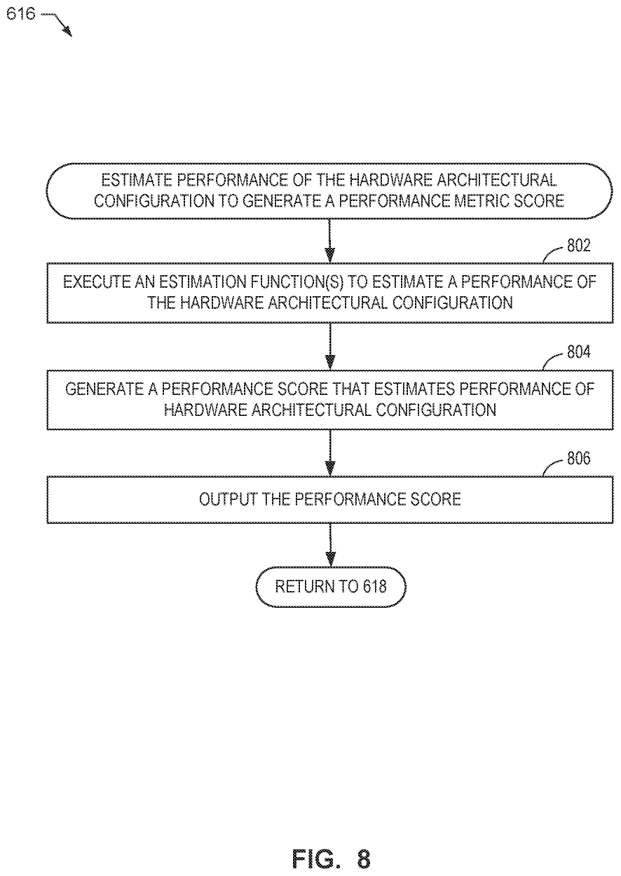

In some examples, the design system 200 includes means for estimating performance of a hardware architecture for a hardware component. For example, the means for estimating performance may be implemented by performance estimator circuitry 230. In some examples, the performance estimator circuitry 230 may be instantiated by processor circuitry such as the example processor circuitry 912 of FIG. 9. For instance, performance estimator circuitry 230 may be instantiated by the example microprocessor 1000 of FIG. 10 executing machine executable instructions such as those implemented by at least blocks 616 of FIG. 6 and 802-806 of FIG. 8. In some examples, the performance estimator circuitry 230 may be instantiated by hardware logic circuitry, which may be implemented by an ASIC, XPU, or the FPGA circuitry 1100 of FIG. 11 structured to perform operations corresponding to the machine readable instructions. Additionally or alternatively, the performance estimator circuitry 230 may be instantiated by any other combination of hardware, software, and/or firmware. For example, the performance estimator circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The configuration manager circuitry 202, between each iteration of the high-fidelity loop 226 and/or the low-fidelity loop 228, determines whether to adjust a hardware architectural configuration. Further, the configuration manager circuitry 202 determines whether to run an additional iteration of a high-fidelity loop 226 and/or a low-fidelity loop 228. In some examples, the configuration manager circuitry 202 determines whether to stop iteration through the loops 226, 228 and to settle on a hardware architectural configuration. For example, the configuration manager circuitry 202 may determine to settle on a hardware architectural configuration based on reaching a threshold aggregate score 220 and/or a threshold performance score 234. In some examples, a user may determine to stop iterations and settle on a hardware architectural configuration. Other criteria may be used to stop iterations and settle on a hardware architectural configuration in additional or alternative examples.

FIG. 5 is a block diagram of an example implementation of the performance evaluator circuitry 210 of FIG. 2 in accordance with the teachings of this disclosure. The performance evaluator circuitry 210 includes example interface circuitry 502, example architecture search circuitry 504, an example search space 506, example performance metric generator circuitry 508, and example design space generator circuitry 512.

The interface circuitry 502 is structured to provide an interface between the performance evaluator circuitry 210 and other components of the design system 200 and/or a user(s). For example, the interface circuitry 502 can facilitate information transfer between the performance evaluator circuitry 210 and a user(s), the simulator circuitry 208, a workload database 212, aggregator circuitry 218, and/or other components.

The architecture search circuitry 504 is structured to apply AI techniques, such as NAS techniques, to search the search space 506 to identify variations of a workload. For example, the performance evaluator circuitry 210 may retrieve a workload from the workload database 212 for simulation by the simulator circuitry 208. The architecture search circuitry 504 can apply a NAS type algorithm to identify variations of the workload to generate a subset of workloads based on the workload. The performance evaluator circuitry 210 may then input the variations of the workload into the simulator circuitry 208 for simulation on the hardware architectural configuration.

The search space 506 is structured to store information, such as a plurality of workloads and variations thereof. For example, the search space 506 can include a different variations of a ResNet type workload and/or other workloads.

The performance metric generator circuitry 508 is structured to monitor simulation(s) of an execution of different workloads on the hardware architectural configuration to generate a performance metric value in view of defined performance objectives. In some examples, the performance metric generator circuitry 508 may determine the performance objectives based on the score function(s) and/or design constraints 204. For example, the performance metric generator circuitry 508 monitors a simulation of a workload to identify performance of the workload based on reducing latency while increasing accuracy. The performance metric generator circuitry 508 monitors the workloads.

The performance evaluator circuitry 210 includes the memory 510, which is structured to store information generated, received, and/or retrieved by the performance evaluator circuitry 210. For example, the memory 510 may be used to store performance metrics generated by the performance metric generator circuitry 508.

The design space generator circuitry 512 is structured to generate a design space performance indicator for each workload in the workload definition(s). The design space generator circuitry 512 plots the performance metrics generated by the performance metric generator circuitry 508 for a first workload and combinations thereof. In some examples, the design space generator circuitry 512 identifies a Pareto front from the plotted performance metrics. In some examples, the design space generator circuitry 512 selects a reference point within the plot, which is used to generate a design space performance indicator for the first workload. For example, the reference point can be used to identify a hypervolume defining an objective design space enclosed by the reference point and the Pareto front. In some examples, the design space performance indicator as generated by the design space generator circuitry 512 represents a size (e.g., area, volume, etc.) of the objective design space.

In some examples, the design space generator circuitry 512 generates a design space performance indicator for each workload defined in the workload definition(s) 214. The design space generator circuitry 512 transmits the generated design space performance indicator for the hardware architectural configuration to the aggregator circuitry 218 to be aggregated.

While an example manner of implementing the design system 200 is illustrated in FIG. 2, one or more of the elements, processes, and/or devices illustrated in FIG. 2 may be combined, divided, re-arranged, omitted, eliminated, and/or implemented in any other way. Further, the example configuration manager circuity 202, example simulator circuitry 208, example performance evaluator circuitry 210, example aggregator circuitry 218, example searcher circuitry 222, example performance estimator circuitry 230, and/or, more generally, the example design system 200 of FIG. 2, may be implemented by hardware alone or by hardware in combination with software and/or firmware. Thus, for example, any of the example configuration manager circuity 202, example simulator circuitry 208, example performance evaluator circuitry 210, example aggregator circuitry 218, example searcher circuitry 222, example performance estimator circuitry 230, and/or, more generally, the example design system 200, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example design system 200 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed to configure processor circuitry to implement the design system 200 of FIG. 2, are shown in FIGS. 6-8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 6-8, many other methods of implementing the example design system 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry to determine a hardware architectural configuration for a hardware component in a multi-workload, multi-modal, and multi-objective setting. The machine readable instructions and/or the operations 600 of FIG. 6 begin at block 602, at which example configuration manager circuitry (e.g., configuration manager circuitry 202) receives example design constraint(s) (e.g., design constraint(s) 204) and/or a baseline hardware architecture (e.g., from a user, etc.). For example, the configuration manager circuitry 202 may receive a baseline hardware architecture that defines hardware components and/or routing between those components and design constraints 204 that define parameters of the baseline architecture that can be adjusted during a design process. In some examples, the configuration manager circuitry 202 generates the baseline hardware architecture based on the design constraints 204.

At block 604, the configuration manager circuitry 202 generates a hardware architectural configuration for a hardware component. The configuration manager circuitry 202 may generate the hardware architectural configuration based on the design constraints 204, the baseline hardware architecture, and/or other data or information. For example, the configuration manager circuitry 202 may randomly determine the hardware architectural configuration. In some examples, configuration manager circuitry 202 may search a design database (e.g., design database 224) based on the design constraints 204 to generate the hardware architectural configuration.

At block 606, the configuration manager circuitry 202 determines whether to simulate the hardware architectural configuration. Simulation of the hardware architectural configuration is a high-fidelity measurement involving an example high-fidelity loop 226 that can be time consuming and computationally expensive. Thus, the configuration manager circuitry 202 may determine to simulate the hardware architectural configuration after one or more low-fidelity loop 228 iterations to determine whether performance of the hardware architectural configuration is in condition for a high-fidelity measurement. When the answer to block 606 is NO, control advances to block 612, discussed below. When the answer to block 606 is YES, control advances to block 608, at which the configuration manager circuitry 202 generates a simulator model 206 for the hardware architectural configuration. For example, the simulator model 206 can be a program or algorithm that simulates an operation(s) of the hardware architectural configuration.

At block 610, example simulator circuitry 208 simulates the hardware architectural configuration to generate an aggregate score corresponding to a plurality of design space performance indicators. For example, the simulator circuitry 208 may execute the simulator model 206 based on one or more workloads as defined in an example workload database (e.g., workload database 212) based on an example workload definition(s) 214 and/or an example score function(s) 216. Example performance evaluator circuitry (e.g., performance evaluator circuitry 210) monitors execution of the workloads on the hardware architectural configuration simulation in view of defined performance objectives to generate performance scores, which are used to generate the design space performance indicators. Further, example aggregator circuitry (e.g., aggregator circuitry 218) aggregates the design space performance indicators to generate an example aggregate score 220. Control then advances to block 618, discussed below.

At block 612, the configuration manager circuitry 202 determines whether to estimate performance of the hardware architectural configuration. Estimation of the hardware architectural configuration is a low-fidelity measurement involving a low-fidelity loop 228 that can use fewer computational resources as compared to a high-fidelity loop 226. Thus, the configuration manager circuitry 202 may determine to estimate performance of the hardware architectural configuration until a threshold score is met to reduce latency associated with the design process. When the answer to block 612 is NO, control advances to block 620, discussed below. When the answer to block 612 is YES, control advances to block 614, at which the configuration manager circuitry 202 encodes an estimation function(s) 232 for the hardware architectural configuration. For example, the estimation function 232 can be a proxy function corresponding to an operation(s) of the hardware architectural configuration.

At block 616, example performance estimator circuitry 230 estimates a performance of the hardware architectural configuration to generate a performance metric score. For example, the performance estimator circuitry 230 may execute the estimation function 232, which serves as a proxy for a simulation of the hardware architectural design, to estimate the performance of the hardware architectural configuration.

At block 618, example searcher circuitry 222 executes a search (e.g., searches) an example database (e.g., database 124) of hardware architectural designs to identify a hardware architectural configuration(s) based on an input score. For example, the searcher circuitry 222 may receive an aggregate score 220 from the performance evaluator circuitry 210 and/or a performance score 234 from the performance estimator circuitry 230. The searcher circuitry 222 can search a design database 224 based on the score 220, 234 to identify hardware architectural configurations that are high performant based in view of the score 220, 234.

At block 620, the configuration manager circuitry 202 determines whether to adjust the hardware architectural configuration to generate another hardware architectural configuration for the hardware component. For example, the configuration manager circuitry 202 may determine to adjust the hardware architectural configuration based on results of the search and/or based on the score 220, 234. In some examples, the configuration manager circuitry 202 may estimate performance of an adjusted hardware architectural configuration to determine whether to adjust the current hardware architectural configuration. For example, if a score 234 of the estimated performance reaches a threshold value, the configuration manager circuitry 202 may determine to adjust the hardware architectural configuration.

When the answer to block 620 is YES, control returns to block 604, at which the configuration manager circuitry 202 generates a hardware architectural configuration for a hardware component (e.g., based on the design constraints 204 and/or hardware architectural configuration identified by the searcher circuitry 222). When the answer to block 620 is NO, control returns to block 622 at which the configuration manager circuitry 202 outputs the hardware architectural configuration.

FIG. 7 is a flowchart representative of example machine readable instructions and/or example operations 610 that may be executed and/or instantiated by processor circuitry to simulate the hardware architectural configuration to generate an aggregate score corresponding to a plurality design space performance indicators. The machine readable instructions and/or the operations 610 of FIG. 7 begin at block 702, at which the performance evaluator circuitry 210 receives the workload definition(s) 214 and/or the score function(s) 216. In some examples, the performance evaluator circuitry 210 receives the workload definition(s) 214 which define workloads to be simulated on the hardware architectural configuration. In some examples, the performance evaluator circuitry 210 receives the score function(s) 216, which define how the defined workloads should information the configuration process (e.g., weights for the workload(s), etc.).

At block 704, the performance evaluator circuitry 210 retrieves one or more workload(s) (e.g., ResNet model, graph learning model(s), etc.) from an example workload database 212. For example, the performance evaluator circuitry 210 may retrieve the workloads based on the workload definition(s) 214. In some examples, the performance evaluator circuitry 210 inputs the workload into the simulator circuitry 208 for execution.

At block 706, the simulator circuitry 208 executes a simulation of the hardware architectural configuration for the workload(s). For example, the simulator circuitry 208 executes a simulation model 206 that simulates the hardware architectural configuration as if it were manufactured. Thus, the simulator circuitry 208 simulates execution of the workloads on the hardware architectural configuration.

At block 708, the performance evaluator circuitry 210 monitors the execution the generate a metric value for the workload(s) based on one or more defined objectives. For example, the performance evaluator circuitry 210 may monitor the simulation to identify a performance of the hardware architectural configuration as it executes the workloads based on accuracy in view of latency, accuracy in view of efficiency, and/or other multi-objective metrics.

At block 710, the performance evaluator circuitry 210 plots the workload based on the (e.g., multi-objective) metric(s) for the simulated workload and/or a variation(s) thereof. For example, the performance evaluator circuitry 210 may plot an output metric for the simulated workload in a graph that compares the multiple objectives. As multiple workload executions complete and are plotted in the graph, a pareto front may be generated, which includes a plurality of linked Pareto points that correspond to multi-objective data points.

At block 712, the performance evaluator circuitry 210 determines whether to generate a variation of the workload. The performance evaluator circuitry 210 may generate multiple variations of the workload to be plotted against each other to generate a design space. In some examples, the performance evaluator circuitry 210 generates a set number of variations, and determine to generate another variation of the workload until the set number is reached. However, the performance evaluator circuitry 210 may use other triggers to determine whether to generate another variation of the workload in additional or alternative examples. When the answer to block 712 is YES, control advances to block 714. When the answer to block 712 is YES, control advances to block 716.

At block 714, the performance evaluator circuitry 210 searches a search space of workloads using neural architecture search (NAS) techniques to generate a variation of the workload. Control then returns to block 706 at which the simulator circuitry 208 simulates execution of the workload variation on the hardware architectural configuration.

At block 716, the performance evaluator circuitry 210 selects a reference point(s) within the graph to generate a design space. The reference point is needed to calculate and define a design space performance indicator. The reference point(s) 412 can be selected (e.g., by user, machine, etc.) using different approaches. In some examples, the reference point(s) 412 can be selected using a rule of thumb, such as selecting a reference point(s) 412 at a corner of a design space that is larger (e.g., 1% larger, larger by an additive term of 1, etc.) than an actual objective space. In some examples, the reference point(s) 412 can be selected as a nadir point.

At block 718, the performance evaluator circuitry 210 generates a design space performance indicator (e.g., metric) representing a multidimensional objective space that includes a set of solutions representing a tradeoff among the different objectives. The performance indicator can be, for example, a hypervolume indicator, an R2 indicator, etc. In examples in which two objectives are measured for each workload and/or modality of interest, the performance indicator may represent an area of an Pareto front. In some examples, a size of an objective design space indicates a fitness of a particular hardware architectural configuration for a corresponding workload. In some examples, the design space performance indicator for a Pareto front is determined as an objective space that is dominated by the Pareto front relative to the reference point(s).

At block 720, the performance evaluator circuitry 210 determines whether to retrieve another workload from the workload database 212. For example, the performance evaluator circuitry 210 may retrieve another workload based on the workload definition(s) 214. If a workload in the workload definition(s) 214 has not been simulated, the performance evaluator circuitry 210 may determine to retrieve another workload. If each workload in the workload definition(s) 214 have been simulated, the performance evaluator circuitry 210 may determine not to retrieve another workload. If the answer to block 720 is YES, control returns to block 706 at which the performance evaluator circuitry 210 retrieves one or more workload(s) (e.g., ResNet model, graph learning model(s), etc.) from the workload database 212. If the answer to block 720 is NO, control advances to block 722.

At block 722, example aggregator circuitry 218 aggregates the design space performance indicators to generate an aggregate score 220. The aggregator circuitry 218 receives or otherwise retrieves the plurality (e.g., set) of design space performance indicators for the hardware architectural configuration from the performance evaluator circuitry 210. The aggregator circuitry 218 aggregates the set of design space performance indicators across the simulated workloads to generate the aggregate score 220. For example, the aggregator circuitry 218 can average the set of design space performance indicators to generate the aggregate score 220. In some examples, the aggregator circuitry 218 can generate the aggregate score 220 based on a format used by example searcher circuitry 222. For example, the searcher circuitry 222 (discuss in detail below) may apply a search algorithm that uses a relative ranking of different scores (e.g., 0-1000, 0-1, etc.). In some such examples, the aggregator circuitry 218 can generate the aggregate score 220 such that the aggregate score 220 is in accordance with the ranking scale.

In some examples, the aggregator circuitry 218 applies weights to the aggregate score 220 for the design space performance indicators to generate a weight aggregate score 220 for the design space performance indicators (e.g., Block 724). For examples, the score function(s) 216 can define how the defined workload(s) should be used to inform the hardware accelerator architecture design process (e.g., by way of a performance indicator(s) and aggregate score). For example, the score function(s) 216 can include performance objectives of interest (e.g., maximize or otherwise increase accuracy, minimize or otherwise reduce latency, etc.), a weight(s) that indicates a greater importance of one or more workloads, etc. For example, if performance of a transformer attention-based workload is more important for an accelerator than performance of a MobileNetV3 convolutional-based workload, the transformer attention-based workload can be given a larger weight in a weighted aggregate score. In some examples, a weighted aggregate score can account for a number of workloads across modalities (e.g., computer vision, NLP, graph learning, etc.). Control then returns to block 618 of FIG. 6.

FIG. 8 is a flowchart representative of example machine readable instructions and/or example operations 616 that may be executed and/or instantiated by processor circuitry to estimate performance of a hardware architectural configuration to generate a performance metric score. The machine readable instructions and/or the operations 616 of FIG. 8 begin at block 802, at which example performance estimator circuitry 230 executes the estimation function(s) 232 to estimate a performance of the hardware architectural configuration. For example, the performance estimator circuitry 230 can execute an estimation (e.g., proxy) function(s) 232 that estimates performance of a hardware architectural configuration to generate a performance score (e.g., metric) 234. In some examples, the executed estimation function(s) 232 can apply a graph-based prediction algorithm to generate the performance score(s) 234. For example, the estimation function 232 can generate a graph representation of a PE array considering that most hardware architectures (e.g., from a circuit design perspective) can be represented as a graph. In some examples, another general regressor (e.g., linear ridge, graph neural network regressor, etc.) can be used. For example, a graph neural network regressor can comprehend the structural components of different accelerator configurations, enabling a more accurate performance metric. However, it is understood that the estimation function(s) 232 can encode a hardware architectural configuration in any number of manners and/or using any suitable method. In some examples, the estimation function 232 represents a hardware architectural configuration as a vector. For example, the estimation function 232 can include a hash table, a dictionary of each of processing element in a processing element array, and/or another structure, with different design variable options associated with each processing element.

At block 804, the performance estimator circuitry 230 generates a performance score 234 that estimates performance of the hardware architectural configuration. The performance estimator circuitry 230 generates a performance score(s) 234 of a hardware architectural configuration based on execution of the estimation function(s) 232. Control then advances to block 806, at which the performance estimator circuitry 230 outputs the performance score 234.

FIG. 9 is a block diagram of an example processor platform 900 structured to execute and/or instantiate the machine readable instructions and/or the operations of FIGS. 6-8 to implement the design system 200 of FIG. 2. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements example configuration manager circuitry 202, example simulator circuitry 208, example performance evaluator circuitry 210, example aggregator circuitry 218, example searcher circuitry 222, and example performance estimator circuitry 230.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 932, which may be implemented by the machine readable instructions of FIGS. 6-8, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 6-8 to effectively instantiate the design system 200 of FIG. 2 as logic circuits to perform the operations corresponding to those machine readable instructions. In some such examples, the design system 200 of FIG. 2 is instantiated by the hardware circuits of the microprocessor 1000 in combination with the instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 6-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 6-8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 6-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 6-8. As such, the FPGA circuitry 1100 may be structured to effectively instantiate some or all of the machine readable instructions of the flowcharts of FIGS. 6-8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 6-8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may be implemented by external hardware circuitry. For example, the external hardware 1106 may be implemented by the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations that may correspond to at least some of the machine readable instructions of FIGS. 6-8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 6-8 may be executed by one or more of the cores 1002 of FIG. 10, a second portion of the machine readable instructions represented by the flowcharts of FIGS. 6-8 may be executed by the FPGA circuitry 1100 of FIG. 11, and/or a third portion of the machine readable instructions represented by the flowcharts of FIGS. 6-8 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

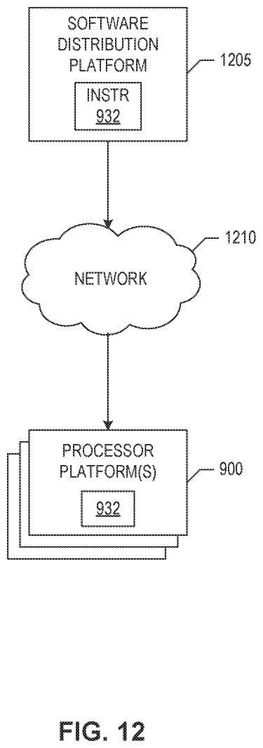

A block diagram illustrating an example software distribution platform 1205 to distribute software such as the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions 600 of FIGS. 6-8, as described above. The one or more servers of the example software distribution platform 1205 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions 600 of FIGS. 6-8, may be downloaded to the example processor platform 900, which is to execute the machine readable instructions 932 to implement the design system 200. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that enable aggregation of a set(s) of workloads and modalities into a single design space performance (e.g., hypervolume, R2, etc.) indicator to be used as a guiding metric for a hardware acceleration configuration process. Disclosed example leverage approaches in neural architecture search (NAS) that enable exploration of a workload(s) and design space to inform a more robust and/or generalizable accelerator architecture. Disclosed systems, methods, apparatus, and articles of manufacture improve the efficiency of using a computing device by providing an improved technique (e.g. computer implemented method) for predicting performance metrics of a hardware component design that considers hardware component performance in the multi-modal, multi-workload, and many-objective setting. Predicting performance of a hardware component can be computationally expensive. Disclosed systems, methods, apparatus, and articles of manufacture improve the efficiency of using a computing device by enabling an estimation of a performance of hardware component during the design process that is less computationally expensive that a full simulation. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for designing hardware are disclosed herein. Further examples and combinations thereof include the following:

Example 1 includes an apparatus to design a hardware component comprising at least one memory; machine readable instructions; and processor circuitry to at least one of instantiate or execute the machine readable instructions to determine a first hardware architectural configuration of a hardware component based on a design constraint; simulate an execution of the first hardware architectural configuration for a plurality of workloads to generate a respective plurality of objective design spaces, the objective design spaces based on one or more objectives; generate an aggregate score by aggregating a plurality of design space performance indicators, ones of the plurality of design space performance indicators corresponding to respective ones of the plurality of objective design spaces; search a design database based on the aggregate score to identify a second hardware architectural configuration; and predict a performance of the second hardware architectural configuration to generate a performance metric by executing a proxy function corresponding to the second hardware architectural configuration.

Example 2 includes the apparatus of example 1, wherein the first hardware architectural configuration is a baseline design, and the second hardware architectural configuration is an adjusted first hardware architectural configuration.

Example 3 includes the apparatus of any preceding clause, wherein the plurality of design space performance indicators are hypervolume indicators.

Example 4 includes the apparatus of any preceding clause, wherein the plurality of design space performance indicators are weighted, and wherein the aggregate score is a weighted aggregate score.

Example 5 includes the apparatus of any preceding clause, wherein a first workload of the plurality of workloads is a deep neural network architecture.

Example 6 includes the apparatus of any preceding clause, wherein the plurality of workloads correspond to one or more modalities.

Example 7 includes the apparatus of any preceding clause, wherein the one or more objectives include at least one of minimize latency, maximize efficiency, or maximize accuracy.

Example 8 includes the apparatus of any preceding clause, wherein executing the proxy function is utilizes fewer compute resources as compared to the simulation of the execution of the first hardware architectural configuration.

Example 9 includes the apparatus of any preceding clause, wherein the performance metric is a first performance metric, and wherein the processor circuitry at least one of instantiates or executes the machine readable instructions to execute a search of the design space for the hardware component based on the first performance metric to determine a third hardware architectural configuration; and predict a performance of the third hardware architectural configuration to generate a second performance metric by executing a proxy function corresponding to the third hardware architectural configuration.

Example 10 includes the apparatus of any preceding clause, wherein, in response to the second performance metric exceeding a defined value, the processor circuitry least one of instantiates or executes the machine readable instructions to simulate an execution of the third hardware architectural configuration for a plurality of workloads to generate a respective plurality of objective design spaces, the objective design spaces based on one or more objectives; generate a design score for the third hardware architectural configuration by aggregating a plurality of design space performance indicators, the plurality of design space performance indicators to correspond to the plurality of objective design spaces; and execute another search of the design space for the hardware component based on the design score for the third hardware architectural configuration to determine a fourth hardware architectural configuration.

Example 11 includes a non-transitory machine readable storage medium comprising instructions that, when executed, cause processor circuitry to at least generate a first configured hardware architecture that represents a hardware device based on a design parameter; simulate an execution of the first configured hardware architecture for multiple workloads to generate objective design spaces, ones of the objective design spaces corresponding to a portion workloads, the objective design spaces based on one or more objectives; generate an combined score by aggregating design space performance indicators, ones of the design space performance indicators corresponding to respective ones of the objective design spaces; search a design database based on the combined score to identify a second configured hardware architecture; and predict a performance of the second configured hardware architecture to generate a performance metric value by executing a proxy function corresponding to the second configured hardware architecture.

Example 12 includes the non-transitory machine readable storage medium of example 11, wherein the first configured hardware architecture is a baseline design, and the second configured hardware architecture is a re-configured first configured hardware architecture.

Example 13 includes the non-transitory machine readable storage medium of any preceding clause, wherein the ones of design space performance indicators are hypervolume indicators.

Example 14 includes the non-transitory machine readable storage medium of any preceding clause, wherein the ones of design space performance indicators are weighted, and wherein the combined score is a weighted combined score.

Example 15 includes the non-transitory machine readable storage medium of any preceding clause, wherein a first workload of the workloads is a deep neural network architecture.

Example 16 includes the non-transitory machine readable storage medium of any preceding clause, wherein the workloads correspond to one or more modalities.

Example 17 includes the non-transitory machine readable storage medium of any preceding clause, wherein the one or more objectives include at least one of minimize latency, maximize efficiency, or maximize accuracy.

Example 18 includes the non-transitory machine readable storage medium of any preceding clause, wherein executing the proxy function is uses employs fewer compute resources as compared to the simulation of the execution of the first configured hardware architecture.

Example 19 includes the non-transitory machine readable storage medium of any preceding clause, wherein the performance metric value is a first performance metric value, and wherein the processor circuitry is to search the design space for the hardware device based on the first performance metric value to determine a third configured hardware architecture; and predict a performance of the third configured hardware architecture to generate a second performance metric value by executing a proxy function corresponding to the third configured hardware architecture.

Example 20 includes the non-transitory machine readable storage medium of any preceding clause, wherein the processor circuitry is to simulate an execution of the third configured hardware architecture for multiple workloads to generate objective design spaces, the objective design spaces based on one or more objectives, a first objective design space based on a first workload and variations of the first workload; generate a design score for the third configured hardware architecture by combining design space performance indicators, ones of the design space performance indicators corresponding to respective ones of the objective design spaces; and search the design space for the hardware device based on the design score for the third configured hardware architecture to determine a fourth configured hardware architecture.

Example 21 includes a method comprising determining, by executing instructions with at least one processor, a first hardware architectural configuration of a hardware component based on a design constraint; simulating, by executing the instructions with the at least one processor, an execution of the first hardware architectural configuration for first workloads and second workloads to generate objective design spaces, the first workloads including a first one of the first workloads and variations of the first one of the first workloads, the second workloads including a first one of the second workloads and variations of the first one of the second workloads, ones of the objective design spaces based on the first workloads and the second workloads, the objective design spaces based on one or more performance objectives; generating, by executing the instructions with the at least one processor, an aggregate score by combining a plurality of design space performance indicators, ones of the plurality of design space performance indicators corresponding to respective ones of the objective design spaces; searching, by executing the instructions with the at least one processor, a design datastore based on the aggregate score to identify a second hardware architectural configuration; and estimating, by executing the instructions with the at least one processor, a performance of the second hardware architectural configuration to generate a performance score by executing an estimation function corresponding to the second hardware architectural configuration.

Example 22 includes the method of example 21, wherein the first hardware architectural configuration is an underlying design, and the second hardware architectural configuration is an improved first hardware architectural configuration.

Example 23 includes the method of any preceding clause, wherein the plurality of design space performance indicators are hypervolume indicators.

Example 24 includes the method of any preceding clause, wherein the plurality of design space performance indicators are weighted, and wherein the aggregate score is a weighted aggregate score.

Example 25 includes the method of any preceding clause, wherein the first one of the first workloads is a deep neural network architecture.

Example 26 includes the method of any preceding clause, wherein the first workloads correspond to a first modality and the second workloads correspond to a second modality.

Example 27 includes the method of any preceding clause, wherein the one or more performance objectives include at least one of minimize latency, maximize efficiency, or maximize accuracy.

Example 28 includes the method of any preceding clause, wherein executing the estimation function is utilizes fewer compute resources as compared to the simulation of the execution of the first hardware architectural configuration.

Example 29 includes the method of any preceding clause, wherein the performance score is a first performance score, and wherein the method further includes searching the design datastore based on the first performance score to determine a third hardware architectural configuration; and predicting a performance of the third hardware architectural configuration to generate a second performance score by executing an estimation function corresponding to the third hardware architectural configuration.

Example 30 includes the method of any preceding clause, wherein, in response to determining that the second performance score exceeds a defined value, the method further including simulating an execution of the third hardware architectural configuration for multiple workloads to generate second objective design spaces, the multiple workloads including the first workloads and the second workloads, ones of the second objective design spaces based on the first workloads and the second workloads, the second objective design spaces based the on one or more performance objectives; generating a second aggregate score by combining a second plurality of design space performance indicators, ones of the second plurality of design space performance indicators corresponding to respective ones of the second objective design spaces; and searching the design datastore based on the second aggregate score to identify a fourth hardware architectural configuration.

Example 31 includes an apparatus to design a hardware component comprising means configuring a first hardware architecture for a hardware component based on a design constraint; means for simulating to simulate an execution of the first hardware architectural configuration for a first workload, first workloads variations, a second workload, and second workloads variation; means for generating a design space performance indicator to generate a first design space performance indicator based on the first workload and the first workload variations and a second design space performance indicator based on the second workload and the second workloads variations; means for aggregating to aggregate the first design space performance indicator and the second design space performance indicator to generate an aggregate score; means for searching a design space to search a design space database based on the aggregate score to identify a second hardware architectural configuration; and means for estimating performance of a hardware architectural configuration to predict a performance metric of the second hardware architectural configuration, the means for estimating performance to predict the performance metric by executing a proxy function corresponding to the second hardware architectural configuration.

Example 32 includes the apparatus of example 31, wherein the first hardware architectural configuration is a baseline design, and the second hardware architectural configuration is an adjusted first hardware architectural configuration.

Example 33 includes the apparatus of any preceding clause, wherein the first design space performance indicator and the second design space performance indicator are hypervolume indicators.

Example 34 includes the apparatus of any preceding clause, wherein the design space performance indicators are weighted, and wherein the aggregate score is a weighted aggregate score.

Example 35 includes the apparatus of any preceding clause, wherein the first workload is a deep neural network architecture.

Example 36 includes the apparatus of any preceding clause, wherein the first workload corresponds to different modality than the second workload.

Example 37 includes the apparatus of any preceding clause, wherein the one or more objectives includes an objective to minimize latency while maximizing accuracy.

Example 38 includes the apparatus of any preceding clause, the means for estimating performance utilizes fewer compute resources than the means for simulating.

Example 39 includes the apparatus of any preceding clause, wherein the performance metric is a first performance metric, and wherein the means for searching a design space is to search the design space database based on the first performance metric to determine a third hardware architectural configuration; and the means for estimating performance is to predict a performance of the third hardware architectural configuration to generate a second performance metric by executing a proxy function corresponding to the third hardware architectural configuration.

Example 40 includes the apparatus of any preceding clause, wherein, in response to the second performance metric exceeding a threshold value, the means for simulating is to simulate an execution of the third hardware architectural configuration for the first workload, the first workloads variations, the second workload, and the second workloads variations; the means for generating a design space performance indicator is to generate design space performance indicators corresponding to a respective plurality of objective design spaces, the objective design spaces based on one or more objectives; the means for generating a design space performance indicator is to generate a third design space performance indicator based on the first workload and the first workload variations and a fourth design space performance indicator based on the second workload and the second workloads variations; the means for aggregating is to aggregate the third design space performance indicator and the fourth design space performance indicator to generate a second aggregate score; the means for searching a design space is to search the design space database based on the second aggregate score to identify a fourth hardware architectural configuration.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to design a hardware component comprising:
at least one memory;
machine readable instructions; and
processor circuitry to at least one of instantiate or execute the machine readable instructions to:
determine a first hardware architectural configuration of a hardware component based on a design constraint;
simulate an execution of the first hardware architectural configuration for a plurality of workloads to generate a respective plurality of objective design spaces, the objective design spaces based on one or more objectives;
generate an aggregate score by aggregating a plurality of design space performance indicators, ones of the plurality of design space performance indicators corresponding to respective ones of the plurality of objective design spaces;
search a design database based on the aggregate score to identify a second hardware architectural configuration; and
predict a performance of the second hardware architectural configuration to generate a performance metric by executing a proxy function corresponding to the second hardware architectural configuration.

2. The apparatus of claim 1, wherein the first hardware architectural configuration is a baseline design, and the second hardware architectural configuration is an adjusted first hardware architectural configuration.

3. The apparatus of claim 1, wherein the plurality of design space performance indicators are hypervolume indicators.

4. The apparatus of claim 1, wherein the plurality of design space performance indicators are weighted, and wherein the aggregate score is a weighted aggregate score.

5. The apparatus of claim 1, wherein a first workload of the plurality of workloads is a deep neural network architecture.

6. The apparatus of claim 1, wherein the plurality of workloads correspond to one or more modalities.

7. The apparatus of claim 1, wherein the one or more objectives include at least one of minimize latency, maximize efficiency, or maximize accuracy.

8. The apparatus of claim 1, wherein executing the proxy function is utilizes fewer compute resources as compared to the simulation of the execution of the first hardware architectural configuration.

9. The apparatus of claim 8, wherein the performance metric is a first performance metric, and wherein the processor circuitry at least one of instantiates or executes the machine readable instructions to:
execute a search of the design space for the hardware component based on the first performance metric to determine a third hardware architectural configuration; and
predict a performance of the third hardware architectural configuration to generate a second performance metric by executing a proxy function corresponding to the third hardware architectural configuration.

10. The apparatus of claim 9, wherein, in response to the second performance metric exceeding a defined value, the processor circuitry least one of instantiates or executes the machine readable instructions to:
simulate an execution of the third hardware architectural configuration for a plurality of workloads to generate a respective plurality of objective design spaces, the objective design spaces based on one or more objectives;
generate a design score for the third hardware architectural configuration by aggregating a plurality of design space performance indicators, the plurality of design space performance indicators to correspond to the plurality of objective design spaces; and
execute another search of the design space for the hardware component based on the design score for the third hardware architectural configuration to determine a fourth hardware architectural configuration.

11. A non-transitory machine readable storage medium comprising instructions that, when executed, cause processor circuitry to at least:
generate a first configured hardware architecture that represents a hardware device based on a design parameter;
simulate an execution of the first configured hardware architecture for multiple workloads to generate objective design spaces, ones of the objective design spaces corresponding to a portion workloads, the objective design spaces based on one or more objectives;
generate an combined score by aggregating design space performance indicators, ones of the design space performance indicators corresponding to respective ones of the objective design spaces;
search a design database based on the combined score to identify a second configured hardware architecture; and
predict a performance of the second configured hardware architecture to generate a performance metric value by executing a proxy function that corresponding to the second configured hardware architecture.

12. The non-transitory machine readable storage medium of claim 11, wherein the first configured hardware architecture is a baseline design, and the second configured hardware architecture is a re-configured first configured hardware architecture.

13. The non-transitory machine readable storage medium of claim 11, wherein the ones of design space performance indicators are hypervolume indicators.

14. The non-transitory machine readable storage medium of claim 11, wherein the ones of design space performance indicators are weighted, and wherein the combined score is a weighted combined score.

15. The non-transitory machine readable storage medium of claim 11, wherein a first workload of the workloads is a deep neural network architecture.

16. The non-transitory machine readable storage medium of claim 11, wherein the workloads correspond to one or more modalities.

17. The non-transitory machine readable storage medium of claim 11, wherein the one or more objectives include at least one of minimize latency, maximize efficiency, or maximize accuracy.

18. The non-transitory machine readable storage medium of claim 11, wherein executing the proxy function is uses employs fewer compute resources as compared to the simulation of the execution of the first configured hardware architecture.

19. The non-transitory machine readable storage medium of claim 18, wherein the performance metric value is a first performance metric value, and wherein the processor circuitry is to:
search the design space for the hardware device based on the first performance metric value to determine a third configured hardware architecture; and
predict a performance of the third configured hardware architecture to generate a second performance metric value by executing a proxy function corresponding to the third configured hardware architecture.

20. The non-transitory machine readable storage medium of claim 19, wherein the processor circuitry is to:
simulate an execution of the third configured hardware architecture for multiple workloads to generate objective design spaces, the objective design spaces based on one or more objectives, a first objective design space based on a first workload and variations of the first workload;
generate a design score for the third configured hardware architecture by combining design space performance indicators, ones of the design space performance indicators corresponding to respective ones of the objective design spaces; and
search the design space for the hardware device based on the design score for the third configured hardware architecture to determine a fourth configured hardware architecture.

21. A method comprising:
determining, by executing instructions with at least one processor, a first hardware architectural configuration of a hardware component based on a design constraint;
simulating, by executing the instructions with the at least one processor, an execution of the first hardware architectural configuration for first workloads and second workloads to generate objective design spaces, the first workloads including a first one of the first workloads and variations of the first one of the first workloads, the second workloads including a first one of the second workloads and variations of the first one of the second workloads, ones of the objective design spaces based on the first workloads and the second workloads, the objective design spaces based on one or more performance objectives;
generating, by executing the instructions with the at least one processor, an aggregate score by combining a plurality of design space performance indicators, ones of the plurality of design space performance indicators corresponding to respective ones of the objective design spaces;
searching, by executing the instructions with the at least one processor, a design datastore based on the aggregate score to identify a second hardware architectural configuration; and
estimating, by executing the instructions with the at least one processor, a performance of the second hardware architectural configuration to generate a performance score by executing an estimation function that corresponding to the second hardware architectural configuration.

22. The method of claim 21, wherein the first hardware architectural configuration is an underlying design, and the second hardware architectural configuration is an improved first hardware architectural configuration.

23. The method of claim 21, wherein the plurality of design space performance indicators are hypervolume indicators.

24. The method of claim 21, wherein the plurality of design space performance indicators are weighted, and wherein the aggregate score is a weighted aggregate score.

25. The method of claim 21, wherein the first one of the first workloads is a deep neural network architecture.

26.-40. (canceled)
